(19) United States
(12) Patent Application Publication
(10) Pub. No.: US 2021/0002309 A1
(43) Pub. Date: Jan. 7, 2021

(54) SILANE COUPLING MATERIAL, SUBSTRATE, AND DEVICE

(71) Applicant: SONY CORPORATION, TOKYO (JP)

(72) Inventors: YOSHITAKA YAGI, KANAGAWA (JP); KOICHI NAGASAWA, KANAGAWA (JP)

(21) Appl. No.: 16/979,580

(22) PCT Filed: Feb. 15, 2019
(86) PCT No.: PCT/JP2019/005600

§ 371 Date: Sep. 10, 2020

(30) Foreign Application Priority Data
Mar. 19, 2018 (JP) 2018-051348

(51) Int. Cl. C07F 7/10; G02F 1/1337

(52) U.S. Cl. CPC C07F 7/10; G02F 1/133719

(57) ABSTRACT

A silane coupling material according to an embodiment of the present disclosure is represented by the following general formula (1) and includes hydrocarbon groups having numbers of carbon atoms different from each other in A and B.

### TECHNICAL FIELD

The present disclosure relates to a silane coupling material used, for example, for surface treatment of a substrate, and a substrate and a device subjected to surface treatment using the silane coupling material.

### BACKGROUND ART

In recent years, a projection liquid crystal display apparatus (a projector) allowing for displaying on a brighter and large screen has been developed. In such a projector, extremely strong light enters a liquid crystal device as a light valve. Accordingly, the liquid crystal device typically uses an inorganic alignment film as an alignment film. For example, a deposited film including silicon oxide (SiO₂) is used for the inorganic alignment film. However, for example, a SiO₂ deposited film is highly hygroscopic, which causes an issue of occurrence of a leakage current among pixels.

In contrast, for example, PTL 1 discloses a liquid crystal display element that suppresses chemical reaction with liquid crystal by subjecting a surface of an inorganic alignment film to silane treatment to cover a hydroxyl group on the inorganic alignment film with a silane coupling material. For example, PTLs 2 and 3 disclose a liquid crystal apparatus having moisture resistance and alignment stability that are improved by subjecting an inorganic alignment film to surface treatment with use of a plurality of kinds of silane coupling materials having different molecular weights, and a method of manufacturing the liquid crystal apparatus.

### CITATION LIST

### Patent Literature

PTL 1: Japanese Unexamined Patent Application Publication No. H8-22009
PTL 2: Japanese Unexamined Patent Application Publication No. 2007-127757
PTL 3: Japanese Unexamined Patent Application Publication No. 2010-20093

### SUMMARY OF THE INVENTION

Incidentally, in a liquid crystal display element including an inorganic alignment film, high light resistance, high moisture resistance, and high alignment stability are desired.

It is desirable to provide a silane coupling material, a substrate, and a device that make it possible to improve light resistance and moisture resistance without decreasing alignment stability.

A silane coupling material according to an embodiment of the present disclosure is represented by the following general formula (1) and includes hydrocarbon groups having numbers of carbon atoms different from each other in A and B.

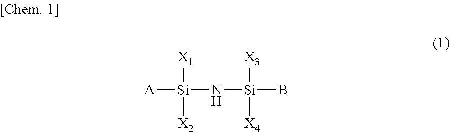

(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)

A substrate according to an embodiment of the present disclosure includes a portion of a molecular structure of the silane coupling material according to the embodiment described above on at least one surface.

A device according to an embodiment of the present disclosure includes a first substrate having functionality. The first substrate has a configuration similar to that of the substrate according to the embodiment described above.

In the silane coupling material according to the embodiment of the present disclosure, the substrate according to the embodiment of the present disclosure, and the device according to the embodiment of the present disclosure, at least one surface of the substrate is subjected to treatment with use of the silane coupling material that is represented by the general formula (1) described above and includes the hydrocarbon groups having the numbers of carbon atoms different from each other in A and B. Accordingly, as the portion of the molecular structure of the silane coupling material described above on the substrate, functional groups having numbers of carbon atoms different from each other are added onto the one surface of the substrate.

According to the silane coupling material according to the embodiment of the present disclosure, the substrate according to the embodiment of the present disclosure, and the device according to the embodiment of the present disclosure, at least one surface of the substrate is subjected to treatment with use of the silane coupling material that is represented by the general formula (1) described above and includes the hydrocarbon groups having the numbers of carbon atoms different from each other in A and B. Accordingly, the functional groups having the numbers of carbon atoms different from each other are added onto the one surface of the substrate. This makes it possible to improve light resistance and moisture resistance without decreasing alignment stability of a substrate surface.

It is to be noted that effects described here are not necessarily limited and may include any of effects described in the present disclosure.

### BRIEF DESCRIPTION OF THE DRAWINGS

FIG. 1 is a ¹³CNMR spectrum diagram of one silane coupling material according to a first embodiment of the present disclosure.

FIG. 2 is a ¹HNRM spectrum diagram of the one silane coupling material according to the first embodiment of the present disclosure.

FIG. 3A is a schematic diagram illustrating a structure of a silane coupling material according to the first embodiment of the present disclosure.

FIG. 3B is a schematic diagram illustrating a configuration of a substrate surface subjected to surface treatment with use of the silane coupling material illustrated in FIG. 3A.

FIG. 4 is a schematic cross-sectional view of a configuration of a liquid crystal display element according to a second embodiment of the present disclosure.

FIG. 5 is a schematic cross-sectional view of another example of a configuration of a liquid crystal display element according to a modification example of the present disclosure.

FIG. 6 illustrates an example of an overall configuration of a projection display apparatus including a liquid crystal display element according to the present disclosure.

FIG. 7 illustrates another example of the overall configuration of the projection display apparatus including the liquid crystal display element according to the present disclosure.

### MODES FOR CARRYING OUT THE INVENTION

In the following, some embodiments of the present disclosure are described in detail with reference to the drawings. The following description is given of specific examples of the present disclosure, and the present disclosure is not limited to the following embodiments. Moreover, the present disclosure is not limited to positions, dimensions, dimension ratios, etc. of respective components illustrated in the respective drawings. It is to be noted that description is given in the following order.

1. First Embodiment (A silane coupling material including two silyl groups having numbers of carbon atoms different from each other)

1-1. Silane Coupling Material

1-2. Surface Treatment Method of Substrate

1-3. Workings and Effects

2. Second Embodiment (An example of a liquid crystal display element in which a surface of an inorganic alignment film is subjected to surface treatment with a silane coupling material)

2-1. Configuration of Liquid Crystal Display Element

2-2. Method of Manufacturing Liquid Crystal Display Element

2-3. Workings and Effects

3. Modification Example (An example of an reflective liquid crystal display element)

### 4. Application Examples

### 5. Examples

### 1. First Embodiment

### (1-1. Silane Coupling Material)

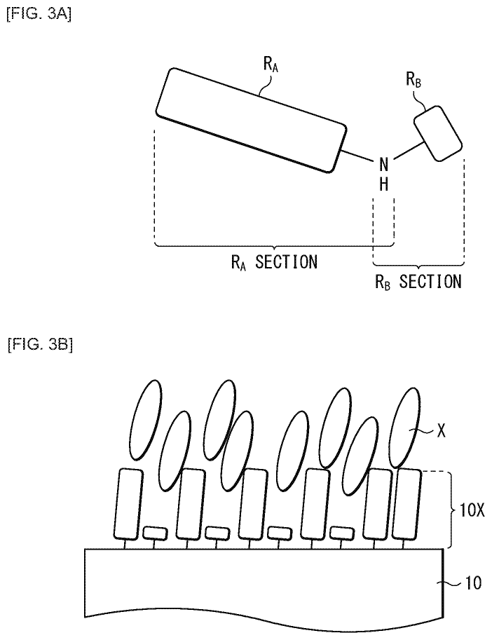

A silane coupling material according to a first embodiment of the present disclosure is represented by the following general formula (1). The silane coupling material makes it possible to add various kinds of functionality such as water repellency to a surface of a substrate 10 (see FIG. 3B), for example, by subjecting the substrate 10 to surface treatment. In addition, as described in detail later, for example, subjecting a surface of a substrate included in a liquid crystal display element (a liquid crystal display element 1, see FIG. 5) to treatment with use of the silane coupling material represented by the general formula (1) makes it possible to add moisture resistance and light resistance without decreasing alignment regulating force of liquid crystal.

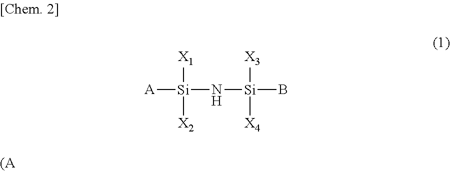

is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)

Specific examples of the silane coupling material represented by the general formula (1) include compounds represented by the following formulas (1-1) to (1-14).

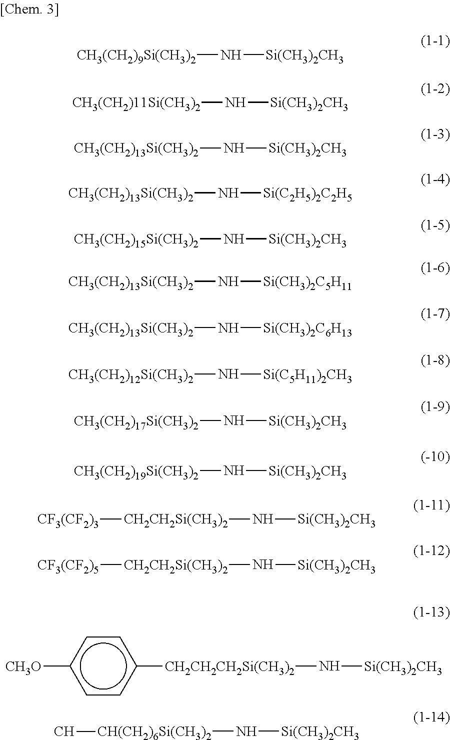

The silane coupling material according to the present embodiment may be synthesized as described below, for example.

For example, 1-decyl-1,1-dimethyl-N-(trimethylsilyl)silaneamine represented by the formula (1-1) is prepared as below. For example, 1,1,3,3-detramethyldisilazane is dissolved in DMSO as a solvent, and thereafter a methylating agent such as iodomethane is added to the solvent, and the solvent is stirred at room temperature for about three hours. After completion of reaction is confirmed with use of GC-MS, the solvent is removed under reduced pressure, and a resultant product is purified by separation and extraction. Next, an thus-obtained compound is dissolved in anhydrous toluene. About 0.01 mol % to about 0.2 mol % of a metal catalyst (for example, Karstedt catalyst) is added to a resultant product, and thereafter about 2 equivalents of olefin ((CH₃)₈CH═CH₂) is added, added to the product. A temperature of the product is increased to 80° C., and thereafter is stirred for 4 to 24 hours. After completion of reaction is confirmed with use of GC-MS, the solvent is removed under reduced pressure, and a resultant product is purified by separation and extraction.

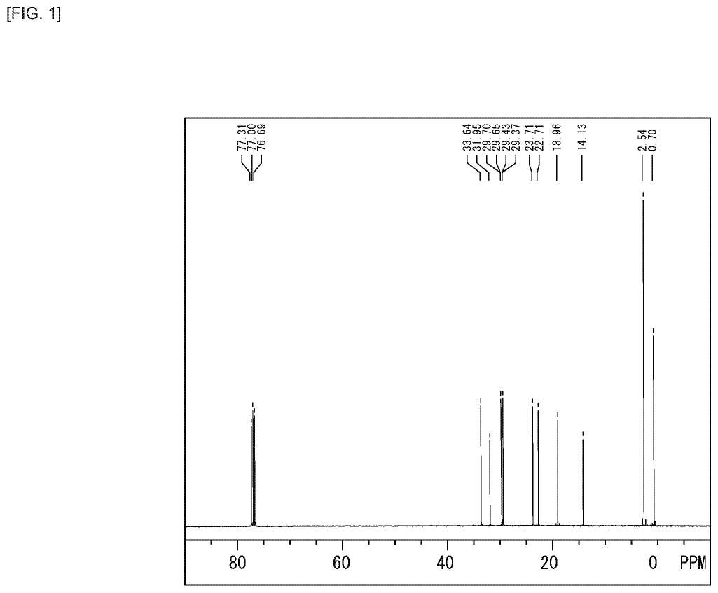

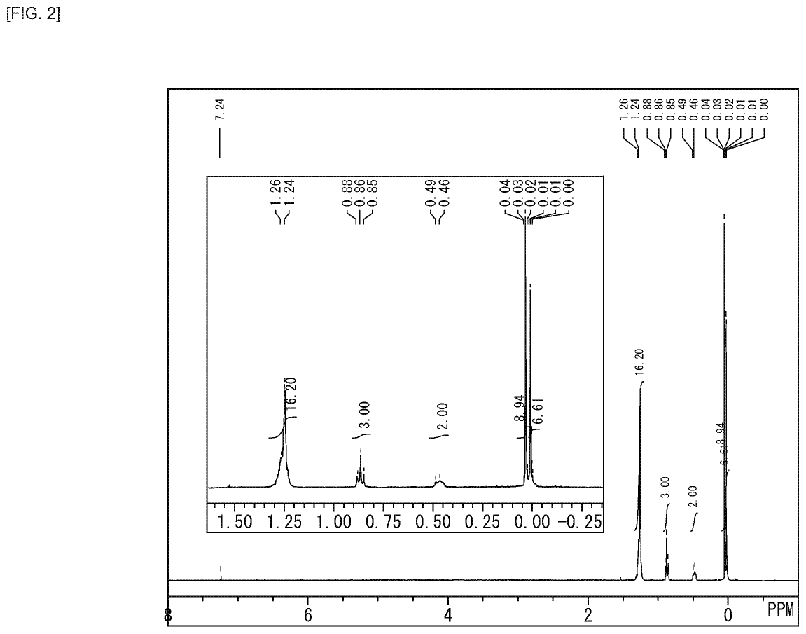

A carbon-13 nuclear magnetic resonance spectrum (¹³C-NMR) and a proton nuclear magnetic resonance spectrum (¹H-NMR) of a compound (1-decyl-1,1-dimethyl-N-(trimethylsilyl)silaneamine) synthesized with use of the method described above were measured, and the following results were obtained. FIG. 1 and FIG. 2 are respectively a ¹³C-NMR spectrum diagram and a ¹H-NMR spectrum diagram of the compound synthesized with use of the method described above. In each of the ¹³C-NMR spectrum and the ¹H-NMR spectrum, the following peaks were confirmed. It is to be noted that CDCl₃ was used as a measurement solvent for both the ¹³C-NMR spectrum and the ¹H-NMR spectrum, and trimethylsilane was used as an internal standard material for the ¹H-NMR spectrum.

¹³C-NMR (100 MHz)

δ: 33.6, 31.9, 29.7, 29.6, 29.4, 29.4, 23.7, 22.7, 19.0, 14.1, 2.5, 0.7

¹H-NMR (400 MHz)

δ: 1.25 (16H), 0.87 (t, J=6.8 Hz, 3H), 0.47 (t, J=7.6 Hz, 2H), 0.03 (s, 3H), 0.01 (s, 3H)

A compound obtained with use of field desorption mass spectrometry (FD-MS) was measured, and the compound had an actual measured value (m/z)=287.2, while 1-decyl-1,1-dimethyl-N-(trimethylsilyl)silaneamine had a calculated value (C₁₅H₃₇NSi₂)=287.2. In addition, the compound had a GC purity of 98.3% (area) %. Thus, synthesis of 1-decyl-1,1-dimethyl-N-(trimethylsilyl)silaneamine as an example of the silane coupling material according to the present embodiment was confirmed.

### (1-2. Surface Treatment Method of Substrate)

FIG. 3A schematically illustrates a molecular structure of the silane coupling material represented by the general formula (1) described above. FIG. 3B schematically illustrates a surface (a surface treatment section 10X) of a substrate (the substrate 10) subjected to surface treatment with use of the silane coupling material represented by the general formula (1). Using the silane coupling material according to the present embodiment for surface treatment of the substrate or the like makes it possible to add various kinds of functionality to the surface of the substrate. Various kinds of glass substrates, a substrate having a surface provided with an inorganic oxide film such as silicon oxide (SiO₂) or an aluminum oxide film (Al₂O₃) are expected as a substrate to be subjected to surface treatment with the silane coupling material.

The silane coupling material according to the present embodiment is a so-called aminosilane-based coupling material in which two kinds of silyl groups having carbon chains different from each other are bound to an amino group. In FIG. 3A, a portion, represented by A in the general formula (1), in which a carbon chain having 6 to 20 carbon atoms is bound to a silyl group is defined as R_{A}, and a section from the portion R_{A} to an amino group is defined as an R_{A} section. In addition, a portion, represented by B in the general formula (1), in which a carbon chain having 1 to 6 carbon atoms is bound to a silyl group is defined as R_{B}, and a section from the portion R_{B} to the amino group is defined as an R_{B} section. The silane coupling material according to the present embodiment allows for a surface treatment method using liquid phase reaction and vapor phase reaction; therefore, the R_{A} section and R_{B} section are bound to the surface of the substrate 10, as illustrated in FIG. 3B.

First, description is given of an example of a surface treatment method using liquid phase reaction. As a liquid phase, 1-decyl-1,1-dimethyl-N-(trimethylsilyl)silaneamine is used as it is, or a liquid phase prepared by dissolving 1-decyl-1,1-dimethyl-N-(trimethylsilyl)silaneamine in a non-polar organic solvent is used. Subsequently, the substrate 10 having a surface on which a SiO₂ deposited film is deposited is placed in a petri dish, for example. Next, 1-decyl-1,1-dimethyl-N-(trimethylsilyl)silaneamine is poured into the petri dish at ordinary temperature to cover a substrate surface. The substrate 10 is left out at ordinary temperature for 10 minutes, for example, and thereafter the substrate 10 is taken out, and is cleaned with use of acetone, for example. Thus, as illustrated in FIG. 3B, the surface treatment section 10X in which the R_{A} section and the R_{B} section are bound randomly to the surface is formed. It is to be noted that, reducing a concentration makes it possible to decrease reaction probability and control a reaction rate by time.

Next, description is given of an example of a surface treatment method using vapor phase reaction. The substrate 10 having a surface on which a SiO₂ deposited film is deposited is placed in a chamber, and the temperature of the substrate 10 is increased to 100° C., for example, with use of nitrogen (N₂) gas heated to high temperature (for example, 100° C.). Subsequently, while a constant amount of nitrogen (N₂) gas flows into the chamber, a pressure and a temperature in the chamber are set to 150 Pa and 100° C., respectively, and a vaporizer is used to cause 1-decyl-1,1-dimethyl-N-(trimethylsilyl)silaneamine to flow into the chamber at a rate of 0.2 g per minute for 10 minutes, for example. At this time, nitrogen (N₂) gas is used as carrier gas. Lastly, the pressure in the chamber is kept at a pressure equal to or lower than a saturated vapor pressure, and remaining 1-decyl-1,1-dimethyl-N-(trimethylsilyl)silaneamine is removed. Thereafter, the gas in the chamber is replaced with nitrogen or atmospheric air, and the substrate 10 is taken out. Thus, as illustrated in FIG. 3B, the surface treatment section 10X in which the R_{A} section and the R_{B} section are bound randomly to the surface is formed.

It is to be noted that the surface treatment using vapor phase reaction described above is performed at a pressure in the chamber lower than the saturated vapor pressure of 1-decyl-1,1-dimethyl-N-(trimethylsilyl)silaneamine, but may be performed at a pressure equal to or higher than the saturated vapor pressure.

### (1-3. Workings and Effects)

In the present embodiment, the silane coupling material that includes hydrocarbon groups having numbers of carbon atoms different from each other in A and B is synthesized as the silane coupling material. This makes it possible to bind, onto one surface of the substrate, silyl groups that are portions of a molecular structure of the silane coupling material represented by the general formula (1) described above and include functional groups having different numbers of carbon atoms by one process. In addition, it is possible to react the silane coupling material according to the present embodiment in both liquid phase reaction and vapor phase reaction.

As described above, as the silane coupling material according to the present embodiment, the silane coupling material that is represented by the general formula (1) and includes hydrocarbon groups having numbers of carbon atoms different from each other in A and B is synthesized, which makes it possible to simply perform surface treatment of the substrate or the like by silane coupling reaction under moderate conditions.

### 2. Second Embodiment

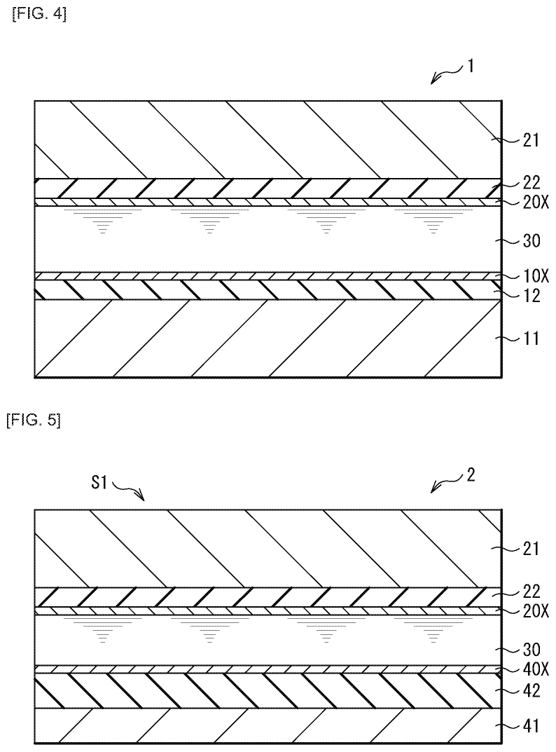

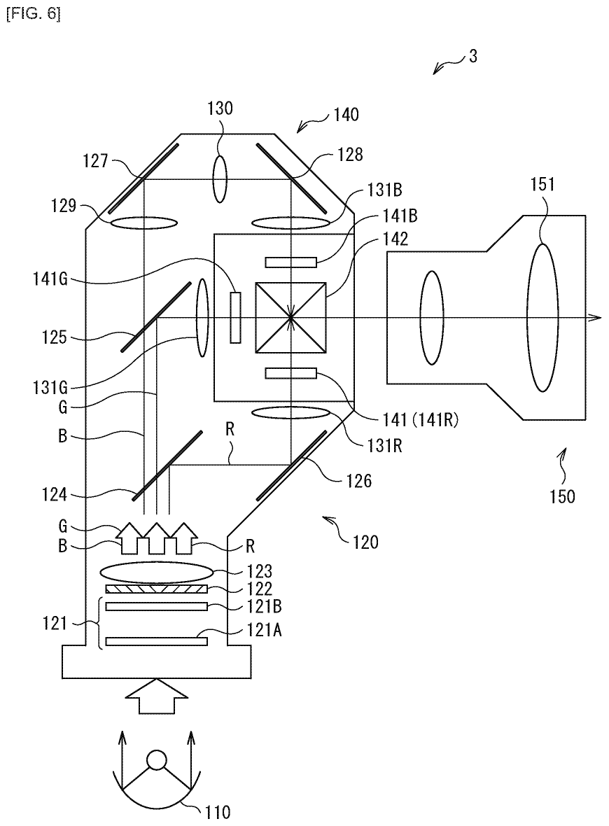

FIG. 4 schematically illustrates a cross-sectional configuration of a liquid crystal display element (the liquid crystal display element 1) according to a second embodiment of the present disclosure. For example, the liquid crystal display element 1 is used as a liquid crystal light valve (for example, a light modulation element 141R) of a projection display apparatus (a projection display apparatus 3, see FIG. 6) such as a projector to be described later. The liquid crystal display element 1 corresponds to a specific example of a “device” of the present disclosure.

### (2-1. Configuration of Liquid Crystal Display Element)

For example, the liquid crystal display element 1 has a configuration in which a pixel circuit substrate 11 and a counter substrate 21 are opposed to each other with a liquid crystal layer 30 interposed therebetween. Alignment films 12 and 22 (inorganic oxide films) are respectively provided on surfaces opposed to the liquid crystal layer 30 of the pixel circuit substrate 11 and the counter substrate 21. A stacking structure of the pixel circuit substrate 11 and the alignment film 12 and a stacking structure of the counter substrate 21 and the alignment film 22 each correspond to the substrate 10 according to the first embodiment described above. Accordingly, in the present embodiment, the liquid crystal display element 1 has a configuration in which the surface treatment section 10X and a surface treatment section 20X are respectively formed on surfaces opposed to the liquid crystal layer 30 of the alignment film 12 and the alignment film 22.

For example, a pixel circuit layer including a transistor is provided on side of a surface, of the pixel circuit substrate 11, opposed to the liquid crystal layer 30 of a light-transmissive substrate, and a pixel electrode is provided on the pixel circuit layer for each pixel, for example (neither the pixel circuit layer nor the pixel electrode is illustrated). The pixel electrode is electrically coupled to the transistor, and the alignment film 12 is provided on the pixel electrode. Although not illustrated, for example, a polarizing plate is joined to a surface, of a substrate included in the pixel circuit substrate 11, opposite to the surface opposed to the liquid crystal layer 30. It is to be noted that a peripheral circuit for driving pixels is formed on a periphery (a peripheral region (not illustrated)) of a pixel region of the pixel circuit substrate 11.

For example, although not illustrated, a counter electrode common to all pixels is provided on side of a surface, of the counter substrate 21, opposed to the liquid crystal layer 30 of the light-transmissive substrate. The alignment film 22 is provided on the counter electrode. Although not illustrated, for example, a polarizing plate is joined to a surface, of a substrate included in the counter substrate 21, opposite to the surface opposed to the liquid crystal layer 30.

For example, the respective substrates included in the pixel circuit substrate 11 and the counter substrate 21 each include a light-transmissive transparent substrate including quartz, glass, or the like. It is to be noted that the pixel circuit substrate 11 may not necessarily be the transparent substrate. The pixel circuit substrate 11 may have a configuration in which the pixel circuit and a reflector are provided on a substrate including silicon or the like. For example, the pixel electrode and the counter electrode may include a light-transmissive electrically-conductive material. Specific examples of such a material include ITO (indium tin oxide) and the like. For example, the polarizing plate includes polyvinyl alcohol (PVA) in which iodine (I) compound molecules are adsorbed and aligned.

For example, the alignment film 12 and the alignment film 22 each include an inorganic material such as silicon oxide (SiO₂), and an aluminum oxide (Al₂O₃) film. The alignment film 12 and the alignment film 22 each preferably have a film thickness in a range from 20 nm to 400 nm both inclusive, for example.

The surface treatment section 10X and the surface treatment section 20X are formed by subjecting the alignment film 12 and the alignment film 22 to surface treatment with use of the silane coupling material represented by the general formula (1) as described above. In the surface treatment section 10X and the surface treatment section 20X, a nitrogen atom (N) of the R_{A} section or the R_{B} section of the silane coupling material represented by the general formula (1) forms a covalent bond with an oxygen atom (O) of the inorganic material included in each of the alignment film 12 and the alignment film 22. The R_{A} section and the R_{B} section are bound randomly to the surfaces of the alignment film 12 and the alignment film 22, thereby improving moisture resistance and light resistance without decreasing the alignment regulating force of the alignment film 12 and the alignment film 22.

The liquid crystal layer 30 may include, for example, various kinds of liquid crystal such as VA (Vertical Alignment) liquid crystal, TN (Twisted Nematic) liquid crystal, or IPS (In-Place-Switching) liquid crystal, and is displayed in a normally black mode or in a normally white (NW) mode, for example. The liquid crystal layer 30 is sealed with, for example, a thermosetting seal material or a UV curable seal material for joining side of the pixel circuit substrate 11 and side of the counter substrate 21 together. The seal materials are commercially available for a liquid crystal display. As for the liquid crystal layer 30, the side of the pixel circuit substrate 11 and the side of the counter substrate 21 are joined together using the seal material, followed by injection of liquid crystal, and the liquid crystal is sealed with a UV curable sealant, for example. Alternatively, for example, the liquid crystal layer 30 may be formed through an ODF (One Drop Fill) process.

### (2-2. Method of Manufacturing Liquid Crystal Display Element)

For example, the liquid crystal display element 1 according to the present embodiment may be manufactured as below.

First, the alignment film 12 is formed through oblique deposition, for example, on the pixel circuit substrate 11. Specifically, a SiO₂ film having a film thickness of, for example, 100 nm is formed, that tilts at an angle in a range from 40° to 70°, for example, with a horizontal direction being set at 0°.

Next, the surface of the alignment film 12 is subjected to silane coupling treatment. Specifically, the pixel circuit substrate 1 on which the SiO₂ deposited film is formed as the alignment film 12 is placed in a chamber, and a temperature of the pixel circuit substrate 11 is increased with use of nitrogen (N₂) gas heated to high temperature (for example, 100° C.). Subsequently, while a constant amount of N₂ gas flows into the chamber, a pressure in the chamber is kept at 150 Pa, for example, and a temperature in the chamber is kept at 100° C., for example. Next, a vaporizer is used to cause vaporized 1-decyl-1,1-dimethyl-N-(trimethylsilyl)silaneamine (the formula (1-1)) to flow into the chamber at a rate of 0.2 g per minute, for example, thereby reacting 1-decyl-1,1-dimethyl-N-(trimethylsilyl)silaneamine with SiO₂. Thus, the surface treatment section 10X is formed on the surface of the alignment film 12.

The alignment film 22 is formed on the counter substrate 21 with use of a similar method, and thereafter the surface treatment section 20X is formed on the surface of the alignment film 22.

Subsequently, the pixel circuit substrate 11 and the counter substrate 21 are joined together with a gap interposed therebetween. Specifically, the pixel circuit substrate 11 and the counter substrate 21 are disposed to cause the surface treatment section 10X and the surface treatment section 20X to be opposed to each other. Thereafter, for example, a UV curable seal material is applied to join the pixel circuit substrate 11 and the counter substrate 21 together except for an inlet around the pixel circuit substrate 11 and the counter substrate 21, and the seal material is irradiated with UV to cure the seal material.

Next, liquid crystal is injected into the gap between the pixel circuit substrate 11 and the counter substrate 21 to form the liquid crystal layer 30. Lastly, the sealant is applied to the inlet, and the sealant is irradiated with UV to cure the sealant. Thus, the liquid crystal display element 1 illustrated in FIG. 4 is completed.

### (2-3. Workings and Effects)

As described above, a liquid crystal device used for a projector allowing for displaying on a brighter and large screen is desired to have high moisture resistance and high light resistance. The liquid crystal device typically uses, as an alignment film, an inorganic deposited film including an inorganic material, for example, silicon oxide (SiO₂); however, the inorganic deposited film is highly hygroscopic, which causes an issue that an inorganic alignment film taking up moisture becomes a cause of occurrence of a leakage current among pixels. As a method of improving moisture resistance of the inorganic alignment film, for example, a surface of the inorganic alignment film is subjected to silane treatment with the silane coupling material, for example, to cover a hydroxyl group on the inorganic alignment film.

Incidentally, in surface treatment of the inorganic alignment film of the liquid crystal device using a vertical alignment mode of nematic liquid crystal, a silane coupling material including an alkyl chain as a functional group is frequently used. The silane coupling material is used for stabilizing alignment of liquid crystal, and increasing a length of the alkyl chain makes it possible to improve alignment stability of liquid crystal; however, the alignment stability tends to decrease gradually as an attached amount becomes too large. Accordingly, there has been an attempt to achieve both moisture resistance and alignment stability by reacting a plurality of kinds of silane coupling materials having different lengths.

In contrast, in the liquid crystal display element 1 according to the present embodiment, the surfaces opposed to the liquid crystal layer 30 of the pixel circuit substrate 11 and the counter substrate 21 are subjected to treatment with use of the silane coupling material that is represented by the general formula (1) described in the first embodiment and includes hydrocarbon groups having numbers of carbon atoms different from each other in A and B. This makes it possible to add silyl groups including functional groups having different numbers of carbon atoms onto the alignment film 12 and the alignment film 22 that are opposed to the liquid crystal layer 30.

As described above, in the present embodiment, the surfaces opposed to the liquid crystal layer 30 of the pixel circuit substrate 11 and the counter substrate 21 are subjected to treatment with use of the silane coupling material that is represented by the general formula (1) described in the first embodiment and includes hydrocarbon groups having numbers of carbon atoms different from each other in A and B. Accordingly, silyl groups including functional groups having different numbers of carbon atoms are added onto the alignment film 12 and the alignment film 22 that are provided on the surfaces opposed to the liquid crystal layer 30 of the pixel circuit substrate 11 and the counter substrate 21. This makes it possible to suppress a decrease in the alignment regulating force of the alignment film 12 and the alignment film 22 while improving coverage of the surfaces of the alignment film 12 and the alignment film 22. That is, this makes it possible to improve light resistance and moisture resistance without decreasing alignment stability.

In addition, as described above, in a case where surface treatment of an inorganic alignment film is performed with use of a plurality of kinds of silane coupling materials that include carbon chains having different lengths, a residue remaining after a process of removing the silane coupling material that has been first processed may possibly decrease device reliability. Further, a surface subjected to treatment may possibly be damaged by irradiation with ultraviolet rays or the like. Furthermore, there is an issue of an increase in manufacturing time in addition to an increase in possibility of contamination due to complication of manufacturing process.

In contrast, in the present embodiment, the silane coupling material that is represented by the general formula (1) and include hydrocarbon groups having numbers of carbon atoms different from each other in A and B is used, which makes it possible to bind, to the alignment film 12 and the alignment film 22, two kinds of silyl groups that include carbon chains having lengths different from each other by one process. This makes it possible to improve light resistance and moisture resistance while maintaining alignment stability without damage to the surface of the substrate and generation of a residue.

Further, in a case where a typically used silane coupling material including a methoxy group is used, it is necessary to perform hydrolytic degradation processing after coating. In contrast, in the silane coupling material represented by the general formula (1) used in the present embodiment, an amino group of the silane coupling material and hydroxyl groups on the surfaces of the alignment film 12 and the alignment film 22 directly react with each other to form a covalent bond. Accordingly, hydrolytic degradation processing is unnecessary, and it is possible to improve reliability of light resistance and moisture resistance. In addition, controlling reaction time makes it possible to adjust an amount of the silyl group attached to the alignment film 12 and the alignment film 22 and to control coverage.

Furthermore, as described above, as an example in which surface treatment of the inorganic alignment film is performed with use of a plurality of kinds of silane coupling materials, for example, in a case where bis(decyldimethylsilyl)amine is reacted as a first kind of silane coupling material, and thereafter HMDS is reacted as a second kind of silane coupling material, bis(decyldimethylsilyl)amine has a molecular weight of 413.87 that is large, and is not easy to be reacted in a vapor phase. In addition, a chlorosilane-based silane coupling material is known as a silane coupling material directly forming a covalent bond; however, the chlorosilane-based silane coupling material has corrosivity with respect to a SUS-based material typically used in manufacturing of electronic devices, and may possibly deteriorate the electronic devices.

In contrast, the silane coupling material used in the present embodiment is an aminosilane-based silane coupling material as represented by the general formula (1); therefore, it is not necessary to worry about deterioration in the electronic devices. In addition, for example, 1-decyl-1,1-dimethyl-N-(trimethylsilyl)silaneamine represented by the formula (1-1) has a molecular weight of 287.63 that is small, which allows for uniform coating in vapor phase reaction. That is, for example, options for reaction conditions are increased, which makes it possible to improve material selectivity for the substrate and the like.

Next, description is given of a modification example of the present disclosure. It is to be noted that components similar to those of the liquid crystal display element 1 according to the second embodiment described above are denoted by same reference numerals, and description thereof is omitted where appropriate.

### 3. Modification Example

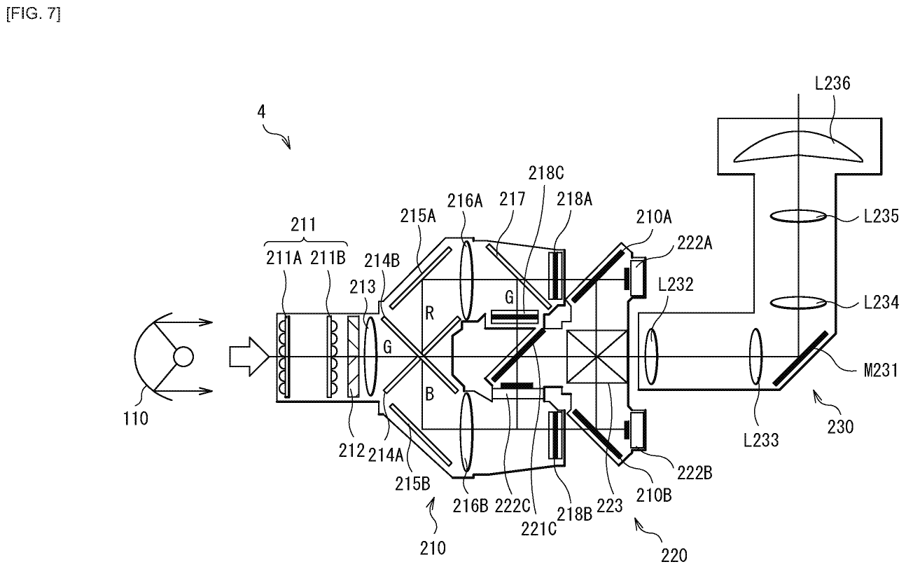

FIG. 5 schematically illustrates an example of a cross-sectional configuration of a liquid crystal display element (a liquid crystal display element 2) according to the modification example of the present disclosure. The liquid crystal display element 2 is used as a liquid crystal light valve of a projection display apparatus (a projection display apparatus 4, see FIG. 7) such as a projector to be described later. The liquid crystal display element 2 corresponds to a specific example of a “device” of the present disclosure.

The liquid crystal display element 2 includes, for example, the liquid crystal layer 30 between a reflector 41 and the counter substrate 21 opposed to each other. A dielectric layer 42 is formed on the reflector 41 opposed to the liquid crystal layer 30, and a surface treatment section 40X is formed on a surface of the dielectric layer 42. Between the counter substrate 21 and the liquid crystal layer 30, as with the second embodiment described above, the alignment film 22 is formed on the counter substrate 21 opposed to the liquid crystal layer 30, and the surface treatment section 20X is formed on the surface of the alignment film 22.

The reflector 41 includes, for example, a light reflective material such as aluminum (Al).

The dielectric layer 42 includes a dielectric material. Specific examples of the dielectric material include SiO₂.

The liquid crystal display element 2 according to the present modification example may be manufactured as below. First, for example, the CVD method is used to form a SiO₂ film, for example, as the dielectric layer 42 with a thickness of 75 nm, for example, on the reflector 41. Next, as with the second embodiment described above, the surface of the dielectric layer 42 is subjected to silane coupling treatment to form the surface treatment section 40X. Thereafter, the reflector 41 and the counter substrate 21 including, on the surface of the alignment film 22, the surface treatment section 20X formed with use of a method similar to that in the second embodiment described above are disposed to cause the surface treatment section 40X and the surface treatment section 20X to be opposed to each other, and are joined to each other with a gap interposed therebetween. Thereafter, liquid crystal is injected into the gap to form the liquid crystal layer 30. Thus, the liquid crystal display element 2 illustrated in FIG. 5 is completed.

As described above, in the present modification example, it is possible to manufacture the reflective liquid crystal display element 2 having superior alignment stability, superior moisture resistance, and superior light resistance by a simpler method. It is to be noted that, in the present modification example, the side of the counter substrate 21 has a configuration similar to that in the second embodiment described above. Therefore, the liquid crystal on the side of the counter substrate 21 is aligned while maintaining its tilt.

### 4. Application Examples

### Application Example 1

FIG. 6 illustrates an example of a configuration of a projection display apparatus (the projection display apparatus 3) including the liquid crystal display element 1 according to the embodiment of the present disclosure. For example, the projection display apparatus 3 includes a light source 110 (a light source), an illumination optical system 120, an image forming section 140, and a projection optical system 150 in this order. The projection display apparatus 3 generates image light by modulating and combining light (illumination light) outputted from the light source 110 for each of RGB colors on the basis of an image signal, and projects an image on a screen (not illustrated). The projection display apparatus 3 is a so-called three-panel transmissive projector that displays a color image using three transmissive light modulation elements 141R, 141G, and 141B for respective colors of red, blue, and green. The light modulation elements 141R, 141G, and 141B correspond to the liquid crystal display element 1.

The light source 110 emits white light including red light (R), blue light (B), and green light (G) that are necessary for displaying a color image. The light source 110 includes, for example, a halogen lamp, a metal-halide lamp, a xenon lamp, or the like. Alternatively, for example, a solid-state light source such as a laser diode (LD) or a light emitting diode (LED) may be used. In addition, the light source 110 is not limited to a single light source (a white light source section) that emits white light as described above. For example, the light source 110 may include three types of light source sections of a green light source section that emits light in a green band, a blue light source section that emits light in a blue band, and a red light source section that emits light in a red band.

The illumination optical system 120 includes, for example, an integrator element 121, a polarization conversion element 122, and a condenser lens 123. The integrator element 121 includes a first fly-eye lens 121A and a second fly-eye lens 121B. The first fly-eye lens 121A includes a plurality of two-dimensionally arrayed microlenses. The second fly-eye lens 121B includes a plurality of microlenses that is arrayed to correspond to the microlenses included in the first fly-eye lens 121A on a one-by-one basis.

Light (parallel light) incident on the integrator element 121 from the light source 110 is split into a plurality of light fluxes by the microlenses of the first fly-eye lens 121A to allow an image to be formed by the corresponding microlenses in the second fly-eye lens 121B. The respective microlenses in the second fly-eye lens 121B function as secondary light sources, and apply, as incident light, a plurality of parallel light beams having uniform luminance to the polarization conversion element 122.

The integrator element 121 as a whole has a function of arranging the incident light applied to the polarization conversion element 122 from the light source 110 to have uniform luminance distribution.

The polarization conversion element 122 has a function of equalizing polarization states of the light incident via the integrator element 121 and the like. The polarization conversion element 122 outputs emission light via a lens 65 or the like disposed on light emission side of the light source 110, for example. The emission light includes blue light B, green light G, and red light R.

The illumination optical system 120 further includes a dichroic mirror 124, a dichroic mirror 125, a mirror 126, a mirror 127, a mirror 128, a relay lens 129, a relay lens 130, a field lens 131R, a field lens 131G, a field lens 131B, the light modulation elements 141R, 141G, 141B, and a dichroic prism 142. The light modulation elements 141R, 141G, 141B and the dichroic prism 142 function as the image forming section 140.

The dichroic mirror 124 and the dichroic mirror 125 have a property of selectively reflecting color light of a predetermined wavelength region and transmitting light of other wavelength regions. For example, the dichroic mirror 124 selectively reflects the red light R. The dichroic mirror 125 selectively reflects the green light G of the green light G and the blue light B that have been transmitted through the dichroic mirror 124. The remaining blue light B is transmitted through the dichroic mirror 125. In such a way, the light (white light Lw) emitted from the light source 110 is split into a plurality of color light beams having different colors.

The split red light R is reflected by the mirror 126, passes through the field lens 131R to be thereby parallelized, and thereafter enters the light modulation element 141R for modulating red light. The green light G passes through the field lens 131G to be thereby parallelized, and thereafter enters the light modulation element 141G for modulating green light. The blue light B passes through the relay lens 129 to be reflected by the mirror 127, and further passes through the relay lens 130 to be reflected by the mirror 128. The blue light B reflected by the mirror 128 passes through the field lens 131B to be thereby parallelized, and thereafter enters the light modulation element 141B for modulating the blue light B.

The light modulation elements 141R, 141G, and 141B are each electrically coupled to an unillustrated signal source (for example, a PC or the like) that supplies an image signal including image information. The light modulation elements 141R, 141G, and 141B modulate, on the basis of supplied image signals of respective colors, incident light for respective pixels, and generate a red image, a green image, and a blue image, respectively. The modulated light beams (formed images) of the respective colors enter the dichroic prism 142 to be combined. The dichroic prism 142 superimposes and combines the light beams of the respective colors incident from the three directions, and outputs the combined light beams toward the projection optical system 150.

The projection optical system 150 includes a plurality of lenses 151 or the like, and applies light combined by the dichroic prism 142 to the unillustrated screen. This allows a full-color image to be displayed.

### Application Example 2

FIG. 7 illustrates an example of a configuration of a projection display apparatus (the projection display apparatus 4) including the liquid crystal display element 2 according to the modification example of the present disclosure. The projection display apparatus 4 includes, for example, the light source 110, an illumination optical system 210, an image forming section 220, and a projection optical system 230 in order. The projection display apparatus 4 generates image light by modulating and combining light (illumination light) outputted from the light source 110 for each of RGB colors on the basis of an image signal, and projects an image on a screen section (not illustrated). The projection display apparatus 4 is a so-called three-panel reflective projector that displays a color image using three reflective light modulation elements 222R, 222G, and 222B for respective colors of red, blue, and green. The light modulation elements 222R, 222G, and 222B correspond to the liquid crystal display element 2.

Similarly to the above-described Application Example 1 described above, the light source 110 emits white light including red light (R), blue light (B), and green light (G) that are necessary for displaying a color image. The light source 110 includes, for example, a halogen lamp, a metal-halide lamp, a xenon lamp, or the like. Alternatively, for example, a solid-state light source such as a laser diode (LD) or a light emitting diode (LED) may be used. In addition, the light source 110 is not limited to a single light source (as white light source section) that emits white light as described above. For example, the light source 110 may include three types of light source sections of a green light source section that emits light in a green band, a blue light source section that emits light in a blue band, and a red light source section that emits light in a red band.

The illumination optical system 210 includes, for example, fly-eye lenses 211 (211A and 211B), a polarization conversion element 212, a lens 213, dichroic mirrors 214A and 214B, reflective mirrors 215A and 215B, lenses 216A and 216B, a dichroic mirror 217, and polarizing plates 218A to 218C from a position close to the light source 110.

The fly-eye lenses 211 (211A and 211B) uniformize illuminance distribution of while light from the light source 110. The polarization conversion element 212 functions to align polarization axes of incident light beams in a predetermined direction. For example, light other than p-polarized light is converted to p-polarized light. The lens 213 condenses light from the polarization conversion element 212 toward the dichroic mirrors 214A and 214B. The dichroic mirrors 214A and 214B each selectively reflect light of a predetermined wavelength region and selectively transmit light of other wavelength regions. For example, the dichroic mirror 214A mainly reflects red light in a direction of the reflective mirror 215A. In addition, the dichroic mirror 214B mainly reflects blue light in a direction of the reflective mirror 215B. Thus, green light mainly passes through both the dichroic mirrors 214A and 214B, and travels toward a reflective polarizing plate 221C of the image forming section 220. The reflective mirror 215A reflects light (mainly red light) from the dichroic mirror 214A toward the lens 216A, and the reflective mirror 215B reflects light (mainly blue light) from the dichroic mirror 214B toward the lens 216B. The lens 216A transmits light (mainly red light) from the reflective mirror 215A, and condenses the light to the dichroic mirror 217. The lens 216B transmits light (mainly blue light) from the reflective mirror 215B, and condenses the light to the dichroic mirror 217. The dichroic mirror 217 selectively reflects green light and selectively transmits light of other wavelength regions. In this example, the dichroic mirror 217 transmits a red light component of light from the lens 216A. In a case where the light from the lens 216A includes a green light component, the green light component is reflected toward the polarizing plate 218C. The polarizing plates 218A to 218C each include a polarizer having a polarization axis in a predetermined direction. For example, in a case where light is converted into p-polarized light in the polarization conversion element 212, the polarizing plates 218A to 218C each transmit the p-polarized light and reflect s-polarized light.

The image forming section 220 includes reflective polarizing plates 221A to 221C, reflective light modulation elements 222A to 222C, and a dichroic prism 223.

The reflective polarizing plates 221A to 221C respectively transmit light (for example, p-polarized light) having the same polarization axes as polarization axes of polarized light from the polarizing plates 218A to 218C, and reflect light (s-polarized light) having polarization axes other than those of the p-polarized light. Specifically, the reflective polarizing plate 221A transmits p-polarized red light from the polarizing plate 218A in a direction of the reflective light modulation element 222A. The reflective polarizing plate 221B transmits p-polarized blue light from the polarizing plate 218B in a direction of the reflective light modulation element 222C. The reflective polarizing plate 221C transmits p-polarized green light from the polarizing plate 218C in a direction of the reflective light modulation element 222C. In addition, the p-polarized green light that has passed through both the dichroic mirrors 214A and 214B and has entered the reflective polarizing plate 221C passes through the reflective polarizing plate 221C without any change, and enters the dichroic prism 223. In addition, the reflective polarizing plate 221A reflects s-polarized red light from the reflective light modulation element 222A to cause the s-polarized red light to enter the dichroic prism 223. The reflective polarizing plate 221B reflects s-polarized blue light from the reflective light modulation element 222C to cause the s-polarized blue light to enter the dichroic prism 223. The reflective polarizing plate 221C reflects s-polarized green light from the reflective light modulation element 222C to cause the s-polarized green light to enter the dichroic prism 223.

The reflective light modulation elements 222A to 222C perform spatial modulation on red light, blue light, and green light, respectively.

The dichroic prism 223 combines incident red light, incident blue light, and incident green light, and outputs thus-combined light toward the projection optical system 230.

The projection optical system 230 includes lenses L232 to L236 and a mirror M231. The projection optical system 230 enlarges light outputted from the image forming section 220 to project the enlarged light on a screen or the like.

### 5. Examples

As described below, a substrate having a surface provided with an inorganic oxide film was subjected to surface treatment with use of the silane coupling material according to the present disclosure (examples 1 to 5) and a liquid crystal display element was fabricated (an example 6).

### Example 1

First, as an experimental example 1, 1-decyl-1,1-dimethyl-N-(trimethylsilyl)silaneamine (having 10 carbon atoms in A and 1 carbon atom in B) represented by the formula (1-1) was heated to 60° C. at normal pressure, and thereafter was placed in enclosed space together with a substrate having a surface provided with a SiO₂ film, and vapor deposition was performed for 60 minutes. In addition, as an experimental example 2, treatment similar to that in the experimental example 1 was performed except that HMDS (having 1 carbon atom) was used and vapor deposition was performed for 30 minutes. Further, as an experimental example 3, treatment similar to that in the experimental example 1 was performed, except that as the silane coupling material, bis(decyldimethylsilyl)amine (having 10 carbon atoms) was used, and a vapor deposition temperature was 140° C. In each of the experimental examples 1 to 3, a contact angle of the substrate was measured, and the surface of the SiO₂ film was analyzed with use of TOF-SIMS. As a result, in the experimental example 1, a fragment specific to the silane coupling materials used in the experimental example 2 and the experimental example 3 was confirmed. That is, in the experimental example 1, it was confirmed that both a silyl group (the R_{A} section) having a carbon chain of 10 carbon atoms and a silyl group (the R_{B} section) having a carbon chain of 1 carbon atom were bound to the surface of the SiO₂ film. It is to be noted that Table 1 is a summary of results of the present example.

TABLE 1

| | | Posi- | Neg- | Posi- | |
|---|---|---|---|---|---|
| | | tive | ative | tive | Contact |
| | | Ion | Ion | Ion | Angle |
| | Compound Name | SiCH₅ | SiCH₃O | SiC₃H₇ | (°) |
| Experimental | 1-decyl-1,1- | A | A | A+ | 74 |
| Example 1 | dimethyl-N- | | | | |
| | (trimethyl- | | | | |
| | silyl)silane amine | | | | |
| Experimental | HMDS | A+ | A+ | B | 76 |
| Example 2 | | | | | |
| Experimental | bis(decyldimethyl- | B | B | A+ | 82 |
| Example 3 | silyl)amine | | | | |

### Example 2

First, a substrate having a surface on which a SiO₂ deposited film was formed was placed in a chamber, and the temperature of the substrate 10 was increased to 100° C., for example, with use of nitrogen (N₂) gas heated to high temperature. Subsequently, while a constant amount of nitrogen (N₂) gas flowed into the chamber, a pressure and a temperature in the chamber were set to 150 Pa and 100° C., respectively, and a vaporizer was used to cause 1-decyl-1,1-dimethyl-N-(trimethylsilyl)silaneamine to flow into the chamber at a rate of 0.2 g per minute for 10 minutes, for example. At this time, nitrogen (N₂) gas was used as carrier gas. Lastly, the gas in the chamber was replaced, and thereafter the substrate 10 was taken out. A contact angle of the substrate was measured. While the contact angle of the substrate not subjected to treatment was 5°, the contact angle of the substrate subjected to the treatment was 70°.

### Example 3

First, a substrate having a surface on which a SiO₂ deposited film was formed was placed in a chamber, and the temperature of the substrate 10 was increased to 100° C., for example, with use of nitrogen (N₂) gas heated to high temperature. Subsequently, while a constant amount of nitrogen (N₂) gas flowed into the chamber, a pressure and a temperature in the chamber were set to 150 Pa and 100° C., respectively, and a vaporizer was used to cause 1-decyl-1,1-dimethyl-N-(trimethylsilyl)silaneamine to flow into the chamber at a rate of 0.2 g per minute with use of nitrogen (N₂) gas as carrier gas. At this time, flowing time (treatment time) was set to 3 minutes, 5 minutes, 10 minutes, 15 minutes, and 30 minutes. Lastly, the pressure in the chamber was kept at 20 Pa for 20 minutes, and remaining 1-decyl-1,1-dimethyl-N-(trimethylsilyl)silaneamine was removed. Thereafter, the gas in the chamber was replaced with nitrogen, and the substrate 10 was taken out. Table 2 is a summary of the contact angle with respect to each treatment time and standard deviation (σ) of measurements for 10 samples. The contact angle was increased in proportion to the treatment time.

TABLE 2

| | Treatment Time (min.) | | | | |
|---|---|---|---|---|---|
| | 3 | 5 | 10 | 15 | 30 |
| Contact Angle (°) | 54 | 60 | 70 | 78 | 84 |
| σ (n = 10) | 0.8 | 1.2 | 1.1 | 1.1 | 1.6 |

### Example 4

First, a substrate having a surface on which a SiO₂ deposited film was formed was placed in a chamber, and the temperature of the substrate 10 was increased to 100° C., for example, with use of nitrogen (N₂) gas heated to high temperature. Subsequently, while a constant amount of nitrogen (N₂) gas flowed into the chamber, a pressure and a temperature in the chamber were set to 500 Pa and 100° C., respectively, and a vaporizer was used to cause 1-decyl-1,1-dimethyl-N-(trimethylsilyl)silaneamine to flow into the chamber at a rate of 0.2 g per minute for 10 minutes. At this time, nitrogen (N₂) gas was used as carrier gas. Lastly, the pressure in the chamber was kept at 20 Pa for 20 minutes, and remaining 1-decyl-1,1-dimethyl-N-(trimethylsilyl)silaneamine was removed. Thereafter, the gas in the chamber was replaced with nitrogen, and the substrate 10 was taken out. A contact angle of the substrate was measured. While the contact angle of the substrate not subjected to treatment was 5°, the contact angle of the substrate subjected to the treatment was 73°.

### Example 5

First, a substrate having a surface on which a SiO₂ deposited film was deposited was placed in a petri dish, and 1-decyl-1,1-dimethyl-N-(trimethylsilyl)silaneamine was poured into the petri dish at ordinary temperature to cover a substrate surface. The substrate was left out at ordinary temperature for 10 minutes, and thereafter the substrate was taken out, and was cleaned with use of acetone. A contact angle of the substrate was measured. While the contact angle of the substrate not subjected to treatment was 5°, the contact angle of the substrate subjected to the treatment was 80°.

It was found from the examples 1 to 5 that it was possible to perform surface treatment of the SiO₂ deposited film in both vapor phase reaction and liquid phase reaction. In addition, it was found that in vapor phase reaction, it was possible to perform surface treatment in a pressure range from ordinary pressure to about several Pa and a temperature range from room temperature to about 250° C. In addition, it was found that a reaction rate was controllable by a concentration of a vapor phase and treatment time.

### Example 6

As an experimental example 4, surface treatment of substrates (a pixel circuit substrate and a counter substrate) each including a SiO₂ film as an inorganic alignment film was performed with use of a method similar to that in the example 2. Next, the pixel circuit substrate and the counter substrate were coated with a seal material, and were superimposed on each other, and the seal material was cured by irradiation with UV. Thereafter, liquid crystal having a negative dielectric constant was injected and sealed between the substrates, thereby fabricating a liquid crystal display element to be driven. In addition, as an experimental example 5, a liquid crystal display element was fabricated with use of a method similar to that described above, except that trimethoxydecylsilane was deposited on a SiO₂ deposited film (an inorganic alignment film), and thereafter hydrolytic degradation was performed. As an experimental example 6, a liquid crystal display element was fabricated with use of a method similar to that in the example 2, except that bis(decyldimethylsilyl)amine was used. In each of the experimental examples 4 to 6, a tilt angle of liquid crystal, a voltage-transmittance curve (V-T), burn-in, and alignment property were evaluated. Table 3 is a summary of these results.

TABLE 3

| | Experimental | Experimental | Experimental |
|---|---|---|---|
| | Example 4 | Example 5 | Example 6 |
| Tilt Angle | 86° | 86° | 86° |
| V-T | Substantially Equal | Reference | Substantially Equal |
| | to Reference | | to Reference |
| Burn-in | Not Confirmed | Not Confirmed | Not Confirmed |
| Alignment | A | B | A |
| Property | | | |

The tilt angle of the liquid crystal was evaluated by a cell gap measurement apparatus of Otsuka Electronics Co., Ltd. Similar results were obtained in all the experimental examples 4 to 6. For the voltage-transmittance curve, voltages causing transmittance to be 10%, 50%, and 90% of a maximum value were measured, but a significant difference between the experimental example 5 as a reference and both the experimental example 4 and the experimental example 6 was not confirmed. Burn-in was evaluated on a gray raster screen after a window was displayed and kept at a center at a maximum driving voltage value for 10 minutes, but burn-in did not occur in any of the experimental examples. For the alignment property, a temperature was gradually decreased from a state in which the temperature exceeded a transparent point of liquid crystal (a phase transition temperature from a nematic state to liquid), and a state of disclination in the nematic state lower than the transparent point was observed. In the experimental example 4 and the experimental example 5, disclination was hardly observed at a point at which the temperature was decreased by 2° C. to 3° C. from the transparent point. In contrast, in the experimental example 6, disclination was observed at a temperature equal to the transparent point −15° C. Thus, it was found that binding two kinds of functional groups to an alignment film surface made it possible to prevent a deterioration in alignment stability.

Although the description has been given with reference to the first and second embodiments, the modification example, and the examples, the present disclosure are not limited to the embodiments and the like described above, and may be modified in a variety of ways. For example, the projection display apparatus according to the present disclosure is not limited to the configuration described in the embodiments described above, and is applicable to various types of display apparatuses that modulate light from a light source via a liquid crystal display unit and display a picture using a projection lens.

In addition, the liquid crystal display element 1 according to the present disclosure may also be used as a liquid crystal light valve of the reflective projection display apparatus 4 described in the application example 2 described above, by adopting a configuration in which a light reflective material is used for the substrate included in the pixel circuit substrate 11 or the pixel electrode, for example.

It is to be noted that the contents of the present disclosure may have the following configurations.

[1]

A silane coupling material that is represented by the following general formula (1) and includes hydrocarbon groups having numbers of carbon atoms different from each other in A and B.

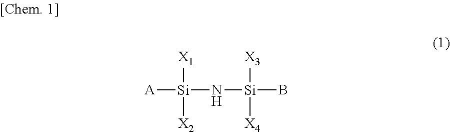

(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)
[2]

The silane coupling material according to [1], in which a difference between the numbers of carbon atoms in the A and the B is 5 or more.

[3]

The silane coupling material according to [1] or [2], in which a difference between the numbers of carbon atoms in the A and the B is 9 or more.

[4]

A substrate including:

a portion of a molecular structure of a silane coupling material on at least one surface, the silane coupling material that is represented by the following general formula (1) and includes hydrocarbon groups having numbers of carbon atoms different from each other in A and B.

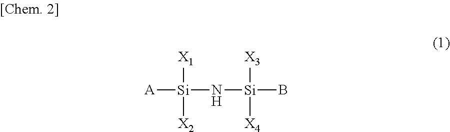

(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)
[5]

The substrate according to [4], in which the one surface includes silyl groups that include hydrocarbon groups having numbers of carbon atoms different from each other.

[6]

The substrate according to [5], in which the hydrocarbon groups having the numbers of carbon atoms different from each other include the A and the B.

[7]

The substrate according to [5] or [6], further including an inorganic oxide film on the one surface, in which

the silyl groups that include the hydrocarbon groups having the numbers of carbon atoms different from each other are bound via an oxygen atom of the inorganic oxide film.

[8]

The substrate according to any one of [5] to [7], in which each of the silyl groups that include the hydrocarbon groups having the numbers of carbon atoms different from each other forms a covalent bond with the oxygen atom of the inorganic oxide film.

[9]

A device including:

a first substrate having functionality,

the first substrate including a portion of a molecular structure of a silane coupling material on at least one surface, the silane coupling material that is represented by the following general formula (1) and includes hydrocarbon groups having numbers of carbon atoms different from each other in A and B.

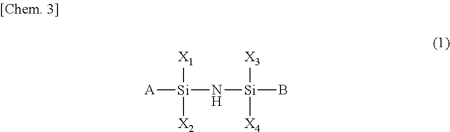

(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)
[10]

The device according to [9], in which the one surface of the first substrate includes silyl groups that include hydrocarbon groups having numbers of carbon atoms different from each other.

[11]

The device according to [9] or [10], in which

the first substrate includes a liquid crystal layer on the one surface, and

the device further comprises a second substrate opposed to the first substrate with the liquid crystal layer interposed therebetween.

[12]

The device according to [11], in which

the first substrate further includes an inorganic oxide film on a surface opposed to the liquid crystal layer, and

the silyl groups that that include the hydrocarbon groups having the numbers of carbon atoms different from each other are bound to the first substrate via an oxygen atom of the inorganic oxide film.

[13]

The device according to [12], in which the inorganic oxide film includes an alignment film.

[14]

A substrate having at least one surface subjected to surface treatment with use of a silane coupling material that is represented by the following general formula (1) and includes hydrocarbon groups having numbers of carbon atoms different from each other in A and B.

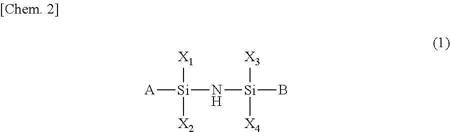

(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)

This application claims the benefit of Japanese Priority Patent Application JP2018-051348 filed with Japan Patent Office on Mar. 19, 2018, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A silane coupling material that is represented by the following general formula (1) and includes hydrocarbon groups having numbers of carbon atoms different from each other in A and B. 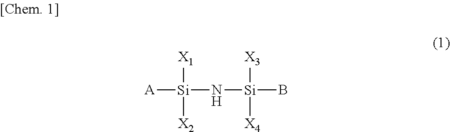
(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)

2. The silane coupling material according to claim 1, wherein a difference between the numbers of carbon atoms in the A and the B is 5 or more.

3. The silane coupling material according to claim 1, wherein a difference between the numbers of carbon atoms in the A and the B is 9 or more.

4. A substrate comprising:
a portion of a molecular structure of a silane coupling material on at least one surface, the silane coupling material that is represented by the following general formula (1) and includes hydrocarbon groups having numbers of carbon atoms different from each other in A and B. 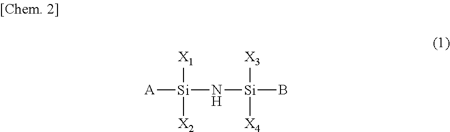
(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)

5. The substrate according to claim 4, wherein the one surface includes silyl groups that include hydrocarbon groups having numbers of carbon atoms different from each other.

6. The substrate according to claim 5, wherein the hydrocarbon groups having the numbers of carbon atoms different from each other include the A and the B.

7. The substrate according to claim 5, further comprising an inorganic oxide film on the one surface, wherein
the silyl groups that include the hydrocarbon groups having the numbers of carbon atoms different from each other are bound via an oxygen atom of the inorganic oxide film.

8. The substrate according to claim 7, wherein each of the silyl groups that include the hydrocarbon groups having the numbers of carbon atoms different from each other forms a covalent bond with the oxygen atom of the inorganic oxide film.

9. A device comprising:
a first substrate having functionality,
the first substrate including a portion of a molecular structure of a silane coupling material on at least one surface, the silane coupling material that is represented by the following general formula (1) and includes hydrocarbon groups having numbers of carbon atoms different from each other in A and B. 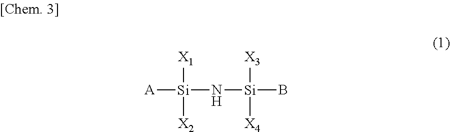
(A is any one of an alkyl group, an alkenyl group, and an alkoxy group each having 6 to 20 carbon atoms, a group in which carbon atoms other than carbon atoms at both ends of a carbon chain included in the alkyl group, the alkenyl group, and the alkoxy group are substituted with any one of an aryl group, a cycloalkyl group, and a cycloalkoxy group, or a group in which hydrogen atoms included in the alkyl group, the alkenyl group, and the alkoxy group are partially or entirely substituted with a fluorine atom; B is any one of an alkyl group, an alkenyl group, and an alkoxy group each having 1 to 6 carbon atoms, or any one of the alkyl group, the alkenyl group, and the alkoxy group in which a carbon atom at an outermost end of a carbon chain is substituted with a phenyl group; and each of X₁ to X₄ is any one of an alkyl group, an alkenyl group, and an alkoxy group each having 1 to 6 carbon atoms.)

10. The device according to claim 9, wherein the one surface of the first substrate includes silyl groups that include hydrocarbon groups having numbers of carbon atoms different from each other.

11. The device according to claim 9, wherein
the first substrate includes a liquid crystal layer on the one surface, and
the device further comprises a second substrate opposed to the first substrate with the liquid crystal layer interposed therebetween.

12. The device according to claim 11, wherein
the first substrate further includes an inorganic oxide film on a surface opposed to the liquid crystal layer, and
the silyl groups that that include the hydrocarbon groups having the numbers of carbon atoms different from each other are bound to the first substrate via an oxygen atom of the inorganic oxide film.

13. The device according to claim 12, wherein the inorganic oxide film includes an alignment film.
